(19) United States
(12) Patent Application Publication
(10) Pub. No.: US 2020/0318291 A1
(43) Pub. Date: Oct. 8, 2020

(54) SYSTEM AND METHODS FOR PRODUCING CONFETTI TO DISSOLVE IN SALT WATER

(71) Applicant: William LOUGHRAN, Sea Girt, NJ (US)

(72) Inventor: William LOUGHRAN, Sea Girt, NJ (US)

(21) Appl. No.: 16/840,779

(22) Filed: Apr. 6, 2020

Related U.S. Application Data
(60) Provisional application No. 62/829,081, filed on Apr. 4, 2019.

(51) Int. Cl. D21H 27/00; B09B 3/00; D21H 25/02

(52) U.S. Cl. CPC D21H 27/00; D21H 25/02; B09B 3/00

(57) ABSTRACT

A sheet is treated with a treatment to make paper dissolve in water. The sheet is cut into various shapes to make confetti. The confetti are used near water. Once in water, the confetti dissolves according to the treatment. The dissolved confetti do not block sunlight or cause problems with the water.

### FIELD OF THE INVENTION

The present invention relates to confetti that dissolves in a salt water environment. More particularly, the present invention relates to a confetti made of paper that is treated to facilitate dissolving in a salt water environment.

### DESCRIPTION OF THE RELATED ART

Confetti may be used for a variety of occasions. Some such occasions may be when a ship enters or leaves a port. For example, confetti may be released before a cruise ship leaves for a voyage. Passengers stand on a deck as the confetti is released. As can be appreciated, confetti collect in the water. Unlike on land, confetti cannot be cleaned up easily while in water. Further, problems may occur as the confetti collects in the harbor or other areas near a ship. The sight may appear unseemly or trashy in that people will throw more trash and debris into the water.

Further, confetti collected on the surface of the water blocks sunlight and possibly oxygen or other gases from entering the water. Sunlight and oxygen are important for aquatic life. Blockage of the sunlight can prevent the growth of plants and other life in the water.

### SUMMARY OF THE INVENTION

A method for dissolving confetti in a salt water environment is disclosed. The method includes placing confetti into water. The confetti include paper having a treatment that reduces a strength of the paper. The method also includes interacting with the salt water using the treatment. The strength of the confetti is reduced according to the interaction. The method also includes reducing the confetti into particles that are not visible. A light ray is reflected within the salt water with the particles.

A method for making confetti used in a salt water environment is disclosed. The method includes treating a sheet with treatment. The treatment facilitates the dissolving of paper in water by reducing a strength of the paper. The method also includes determining a shape for the confetti. The method also includes cutting the sheet to produce confetti having the shape.

A system to produce the confetti also is disclosed.

### BRIEF DESCRIPTION OF THE DRAWINGS

FIG. 1 illustrates an environment for use of confetti in water according to the disclosed embodiments.

FIG. 2 illustrates an example of confetti according to the disclosed embodiments.

FIG. 3 illustrates a system to produce confetti according to the disclosed embodiments.

FIG. 4 illustrates a flowchart for making confetti that dissolves in water according to the disclosed embodiments.

FIG. 5 illustrates a flowchart for dissolving confetti in water according to the disclosed embodiments.

### DETAILED DESCRIPTION OF THE EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

The disclosed embodiments provide confetti that dissolves in water after use. Preferably, the confetti is treated with a process and using this treatment to accelerate the dissolving process into a few minutes as opposed to days. The confetti may be used in an aquatic environment without impact. The confetti do not collect and pollute the water. It also improves the appearance after use in not looking like trash or pollution. The confetti also degrades without releasing toxins or chemicals into the water.

Another feature of the disclosed confetti is that use will not block sunlight from reaching to life under the water. Plant life and creatures that depend on sunlight are not severely impacted from use of the confetti. Confetti that takes days or weeks to dissolve may block sunlight from reaching these plants or creatures. Further, one may not be able to see under the water to gauge depth or see hazards as the confetti floats on top. As ships may leave a port repeatedly, the continued build up of confetti may cause severe problems.

Thus, the disclosed embodiments overcome these limitations of conventional confetti by treating the materials during production. The confetti are created with a process that accelerates dissolving in water. Sheets for the confetti may be treated with a solution that promotes the breakdown of the paper in water.

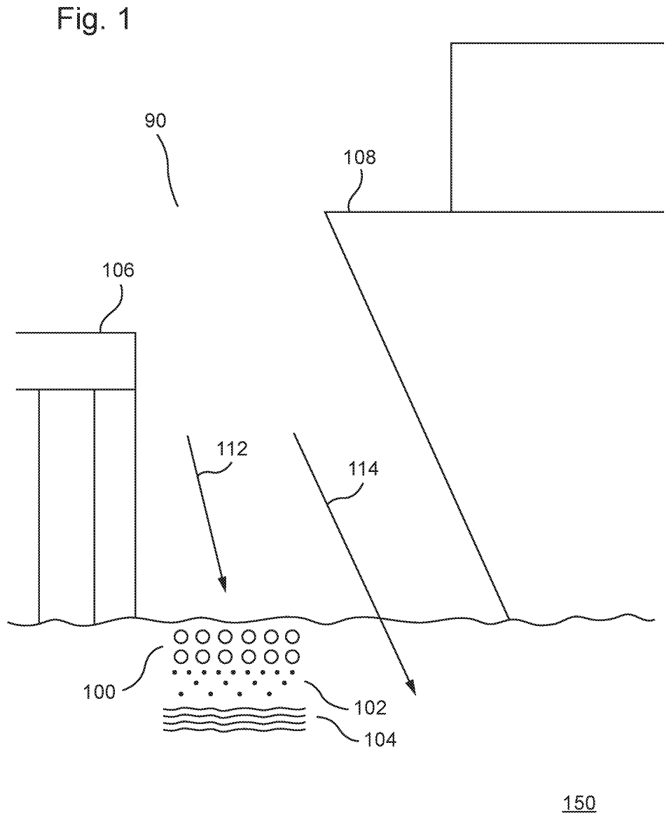

FIG. 1 depicts a salt water environment 90 for use of confetti 100 in salt water 150 according to the disclosed embodiments. Confetti 110 are shown on the top of salt water 150. Salt water may refer to sea water or water in a harbor, port, and the like that receives salt water. In some embodiments, fresh water may be used. Confetti 100 dissolves over a short period of time, such as a few minutes or hours, into decomposed particles 102. Decomposed particles 102 may be the paper of confetti 100 broken into smaller pieces or particles. After another short period of time, such as a few minutes, decomposed particles 102 break down further into particles 104. Particles 104 are dissolved into water 150 such that they are not visible and allow sunlight, oxygen, and other environmental conditions to be absorbed into water 150.

Confetti 110 may be defined as small bits of paper or streamers, sometimes colored, used at festive events to enhance the gaiety of the event. Confetti 110 may be thrown from a height from which it gently drifts downward. Confetti 110 may be in various shapes, specific for the event or other criteria. Alternatively, confetti 110 may just be small pieces of paper. Confetti 110 also may be a streamer having a long rectangular shape. A streamer may not be separated into many pieces but one long piece.

As can be seen in environment 90, a pier 106 is near a ship 108. Ship 108 may be any water-going vessel. In alternative embodiments, no ship is within environment 90. Perhaps environment 90 is near water and confetti 100 are released after a celebration or special event, such as a wedding. Pier 106 also may be any structure near water 150. People or vehicles do not necessarily need to be on pier 106. These features are shown to illustrate how confetti 100 may be used.

Confetti 100 block sunlight rays 112 from penetrating the surface of water 150. As can be seen, confetti 100 prevents sunlight rays 112 from reaching anything below the surface. As confetti 100 dissolve, the sunlight rays can penetrate into water 150. Sunlight rays 114 show this feature. Rays 114 reach below the surface of the water. Particles 104 decompose enough to allow the sunlight rays through. Further, as confetti 100 decompose, particles 104 are dispersed within water 150 to further separate the materials blocking the sunlight rays.

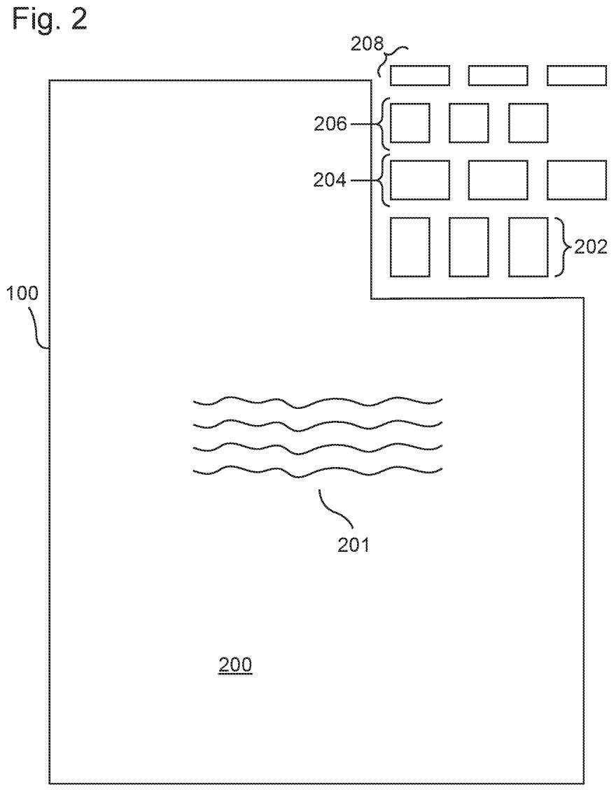

FIG. 2 depicts an example of confetti 100 according to the disclosed embodiments. Preferably, confetti 100 are comprised of paper or a paper-related product. Confetti 100 may come in sheets or rolls of paper 200. Sheet 200 may resemble a sheet of paper in FIG. 2, but this feature is not limited to such a shape. The shape is shown for illustrative purposes only. Sheet 200 may be cut into various shapes to make confetti 100. A cutting process is implemented on sheet 200 to create the desired shapes. Any shape may be created. Alternatively, the disclosed embodiments may create a streamer that is used like confetti. A streamer may be released from one's hand as ship 108 leaves port.

Shapes 202, 204, 206, and 208 are shown being generated from sheet 200. As shown in FIG. 2, the shapes differ from each other. This feature is shown to disclose that sheet 200 is not always cut into the same shape. Shapes 202 and 204 show confetti having a rectangular shape, but oriented differently coming off sheet 200. Shape 206 shows square-shaped confetti. Shape 208 also shows rectangular confetti but having a smaller width that shapes 202 and 204. As can be appreciated, the confetti cut from sheet 200 do not need to have block shapes, but may be circular, triangular, and the like. The shape of the confetti may be jagged. Further, the confetti may be bent after the cutting process or bent while still in sheet 200.

Prior to generating shapes 202-208, sheet 200 also is treated with treatment 201. Treatment 201 includes processes and materials to promote the dissolving of sheet 200 in water. Such materials may be chemicals applied to sheet 200 during the manufacturing process. The chemicals or materials are not harmful to aquatic life after it is dissolved in water. After confetti 100 dissolves in water 150, treatment 201 along with the materials for the confetti do not significantly increase or decrease the pH level, the conductivity, temperature, hardness, or alkalinity of the water.

Treatment 201 also may include not using wet-strength additives in the paper manufacturing. Alternatively, treatment also may include removing these additives after manufacturing. Such treatments may not use or may remove various chemicals such as epichlorohydrin, melamine, urea formaldehyde, and polyamines. These substances may polymerize in paper to result in strengthening the resulting product. The treatment of the disclosed embodiments may remove these chemicals from the paper or the paper manufacturing process.

Treatment 201 also may remove cationic starch from the manufacturing process or from the paper. Use of the starch may increase interconnections between fibers. The treatment seeks to perform the opposite. Interconnections between the fibers are reduced so that that paper used for confetti 100 is not as strong as normal paper.

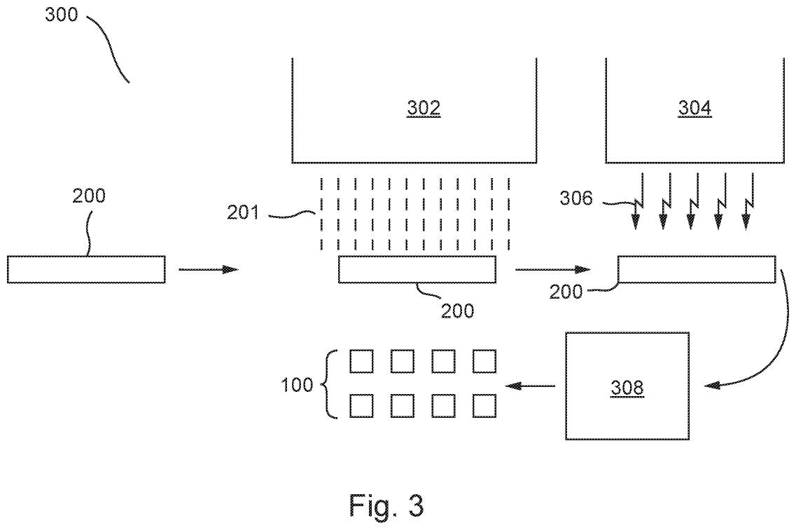

FIG. 3 illustrates a system 300 to produce confetti 100 according to the disclosed embodiments. System 300 may be implemented in factory or warehouse setting. The components of system 300 may include additional items not shown in FIG. 3. Further, system 300 is illustrative of a preferred system but other systems may be implemented.

System 300 receives sheet 200, as disclosed above. Sheet 200 is made of paper. Treatment applicator 302 then receives sheet 200. Treatment 201, as disclosed above, is applied to sheet 200. Treatment 201 is supplied to treatment applicator 302 or it may be stored therein. Treatment 201 facilitates the dissolving of confetti 100 in water. Preferably, treatment 201 is sprayed or applied to sheet 200.

As disclosed above, treatment 201 may be a process performed during the manufacturing process to reduce the strength of the paper. In some embodiments, chemicals or starches may not be added in the normal manufacturing process.

Drying apparatus 304 may be used in system 300 to dry treatment 201 on sheet 200. Treatment 201 may dry fairly quickly after application such that no drying steps are needed. In those instances that treatment 201 does not dry quick enough for manufacturing demands, drying apparatus 304 applies heat or light 306 to sheet 200 to dry treatment 201. Sheet 200 should not remain wet during the later cutting process. Sheet 200 also may be exposed to heat or light 306 using other components or being left alone to dry.

System 300 then moves sheet 200 to cutting apparatus 308 to cut the sheet into desired shapes for confetti 100. Cutting surfaces and blades may be used to cut sheet 200. Treatment 201 is still on the cut pieces that end up as confetti 100. In some instances, sheet 200 may be shredded into confetti 100. Confetti 100 may be placed in a box or bag to be collected with other confetti before being bagged up to be sent for purchase.

System 300 may be controlled by a software program that executes instructions using a processor. The software program may operate all the components of system 300. Instructions may be received at these devices to perform the actions disclosed herein. Alternatively, human operators may control the flow of sheet 200 and creation of confetti 100. Once a task is complete within system 300, sheet 200 is moved to the next device until confetti 100 is bagged or boxed.

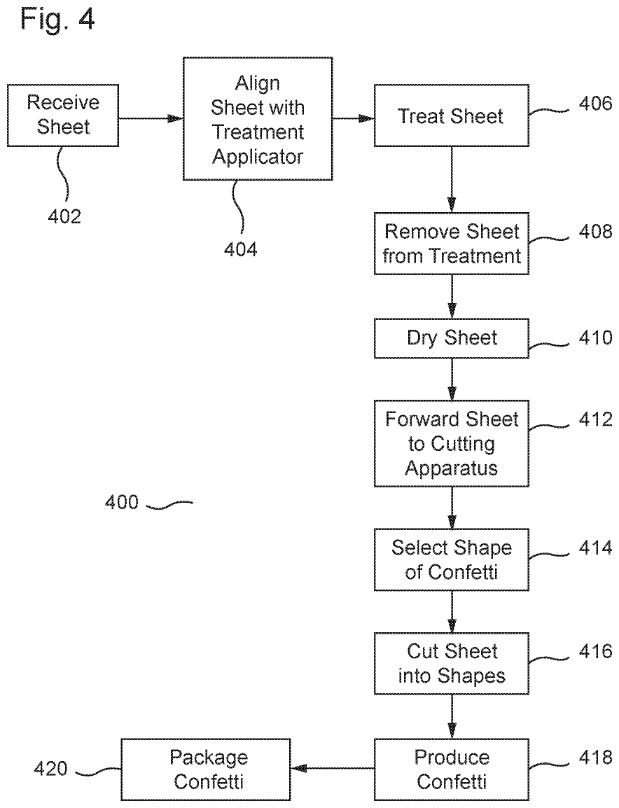

Such instructions may implement flowchart 400 of FIG. 4. FIG. 4 depicts flowchart 400 for making confetti 100 that dissolves in water 150 according to the disclosed embodiments. Flowchart 400 may refer back to components shown in FIGS. 1-3. Flowchart 400, however, is not limited to the embodiments disclosed by FIGS. 1-3.

Step 402 executes by receiving sheet 200 within system 300. As noted above, sheet 200 may refer to a roll of paper or merely a “sheet” of pre-cut paper. It would may refer to paper already used in the course of business, such as “recycled” paper that has been used once and is to be used to make confetti 100. Any size, shape, color, or texture of paper may be used. Sheet 200 is received and placed, preferably, on some device that moves the sheet within system 300.

Step 404 executes by aligning sheet 200 with treatment applicator 302. System 300 does not want sheet 200 to be laying partially outside its application area. System 300 makes sure sheet 200 is aligned properly. Step 406 executes by treating sheet 200 with treatment 201. As shown in FIG. 3, treatment 302 may be sprayed onto sheet 200. Other methods may be used to apply treatment 201, such having it applied using a roller. Treatment 201 is rolled onto sheet 200. Applicator 302 may include sensors to detect when enough treatment 201 is applied so that the applicator stops.

In some embodiments, the treatment is a process that reduces the strength of sheet 200. Sheet 200 is treated to chemically remove the chemicals or starches that increase the connectivity of the fibers in sheet 200. The disclosed embodiments reduce the strength of sheet 200 to encourage the connectivity to reduce or break when exposed to salt water.

Step 408 executes by removing sheet 200 from treatment by treatment applicator 302. This step may execute using a platform to move sheet 200. Sheet 200 is moved to drying apparatus 304. Step 410 executes by drying sheet 200 with treatment 201. Sheet 200 may be dried in a certain fashion, such as applying heat or light to the surface. A sensor in drying apparatus 304 may detect that sheet 200 is dry to stop drying operations so as to not dry out sheet 200 to make it brittle. Step 410 also may be skipped if no drying operations are needed.

Step 412 executes by forwarding sheet 200 to cutting apparatus 308. Step 414 executes by selecting a shape for confetti 100. One may select a shape from a menu and cutting apparatus 308 is programmed to configure its blades or cutting tools to make the shape. Step 416 executes by cutting sheet 200 into the shape for confetti 100. As confetti 100 is made, cutting apparatus 308 may collect the confetti until a certain amount is created. More sheets or paper are used to make more confetti. Thus, step 418 executes by producing confetti 100 until a desired amount is provided. The desired amount may be a certain weight or volume to fit into containers or bags to ship confetti 100. Step 420 executes by packaging confetti 100 for shipment.

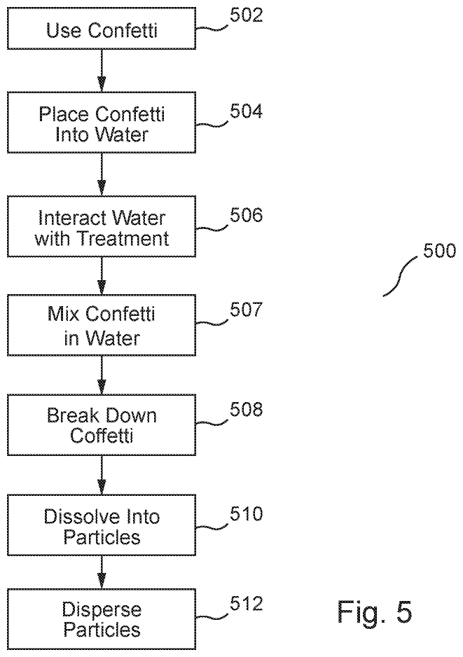

FIG. 5 depicts a flowchart 500 for dissolving confetti 100 in salt water 150 according to the disclosed embodiments. Flowchart 500 may refer back to components shown in FIGS. 1-3. Flowchart 500, however, is not limited to the embodiments disclosed by FIGS. 1-3.

Step 502 executes by using confetti 100 as normal. Referring back to FIG. 1, confetti 100 may be thrown or released from ship 108 or pier 106. People may throw it in the air to celebrate ship 108 leaving or arriving in port. Step 504 executes by placing confetti 100 into water 150. Confetti 100 floats down to the surface of the water. Alternatively, it may be swept or thrown into water 150.

Step 506 executes by interacting salt water 150 with treatment 201 on confetti 100. Treatment 201 facilitates the dissolving or break down of the paper used to make confetti 100. The strength of the paper comprising confetti 100 is reduced through this process. The connectivity of the fibers in the paper is compromised so that the paper falls apart easier than normal. Step 507 executes by mixing confetti 100 with salt water 150 to facilitate the decomposition of the confetti. In some instances, confetti 100 may sit in the water. One may mix the confetti for up to two hours to promote the breaking down of the connectivity of the fibers in the paper and to reduce the strength of the paper.

Step 508 executes by breaking down confetti 100 into decomposed paper 102. Decomposed paper 102 may be broken pieces of confetti or confetti partially dissolved in the water. Step 510 executes by dissolving decomposed paper 102 into particles 104. Particles 104 may be the chemical and materials used to make paper. Step 512 executes by dispersing particles 104 into water 150. After dispersing, the particles making confetti 100 are not seen and do not block light or air getting into water 150.

It will be apparent to those skilled in the art that various modifications to the disclosed embodiments may be made without departing from the spirit or scope of the invention. Thus, it is intended that the present invention covers the modifications and variations disclosed above provided that these changes come within the scope of the claims and their equivalents.

1. A method for dissolving confetti in a salt water environment, the method comprising:
placing confetti into water, wherein the confetti include paper having a treatment that reduces a strength of the paper;
interacting with salt water using the treatment on the confetti, wherein the strength of the confetti is reduced according to the interaction; and
reducing the confetti into particles that are not visible, wherein a light ray is reflected within the salt water with the particles.

2. The method of claim 1, further comprising decomposing the paper in the water.

3. The method of claim 1, further comprising dispersing the particles in the water.

4. The method of claim 1, further comprising mixing the confetti with the salt water.

5. The method of claim 4, wherein the mixing includes moving the confetti in the salt water.

6. The method of claim 5, wherein the moving includes moving the confetti for less than two hours.

7. A method for making confetti used in a salt water environment, the method comprising:
treating a sheet with treatment, wherein the treatment facilitates the dissolving of paper in salt water by reducing a strength of the paper;
determining a shape for the confetti; and
cutting the sheet to produce confetti having the shape.

8. The method of claim 7, wherein the treating includes applying the treatment to the sheet.

9. The method of claim 7, wherein the treating includes removing a chemical from the sheet.

10. The method of claim 7, further comprising drying the sheet after receiving the treatment.

11. A system to produce the confetti using the method of claim 7.
